(19) United States
(12) Patent Application Publication
(10) Pub. No.: US 2012/0210630 A1
(43) Pub. Date: Aug. 23, 2012

(54) Insect-Control Patch

(75) Inventors: Doyle Ashley, Omaha, TX (US); Nigel David Christopher, Mount Pleasant, TX (US)

(73) Assignee: Dead Bug Ventures, LLC, Omaha, TX (US)

(21) Appl. No.: 13/033,069

(22) Filed: Feb. 23, 2011

(51) Int. Cl. A01M 1/20; B32B 37/02

(52) U.S. Cl. 43/132.1; 156/60

(57) ABSTRACT

Apparatus and methods for controlling insects. Some embodiments provide apparatus (for instance patches) comprising one or more layers of degradable materials impregnated with respective insect-control materials. A first impregnated layer defines an effective thickness and degrades at a rate dependent on an environmental factor to thereby expose a portion of the insect-control material impregnated therein at a depth corresponding to the decreased thickness. As the first degradable layer degrades in a multi-layer insect-control patch it also exposes the second layer (which is attached to the first layer) at a rate corresponding to the degradation of the first layer. A barrier impervious to the second insect-control material can be attached to the second layer. In some embodiments the first and second degradable materials are the same material and the second impregnated layer is formed on the first impregnated layer thereby bonding them together.

### BACKGROUND

Many insects irritate and/or harm farm animals, domestic pets, and other types of animals. The animals often respond to these pests by altering their behavior. Cattle, for instance, sometimes migrate to locations under trees and other sources of shade where many insects tend to be less prevalent. In other instances the cattle gather together with the apparent effect being that the insects have a larger number of targets. Hence, for any particular head of cattle, the number of insect bites might be less than would otherwise be the case. Thus, the cattle respond in one way or another to the insects. Such responses though sometimes decrease the quality and quantity of the foodstuffs that the cattle graze. For instance, plants growing in shade can be smaller and offer less nutrition than plants growing in direct sunlight. When a herd congregates together, moreover, the cattle sometimes compete with each other for the foodstuffs available in their vicinity. Thus, the end results often include cattle which gain less weight than desired and suffer reduced value at market.

While the value of various farm animals can be impaired by insect infestations (or even normal insect populations), it is also the case that seeing other domesticated animals experiencing similar distress might not be enjoyable. For instance, watching a dog or cat scratch and writhe about trying to relieve the discomfort caused by biting insects is unpleasant. For humans, of course, such distress can be easily observed and verbalized.

### SUMMARY

The following section presents a simplified summary in order to introduce some aspects of the disclosed subject matter. This summary is not an extensive overview of the disclosed subject matter, and is not intended to identify key or critical elements or to delineate the scope of such subject matter. A purpose of the summary is to present some concepts in a simplified form as a prelude to the more detailed disclosure that is presented herein.

Thus, some embodiments disclosed herein provide patches for use in repelling, killing, and/or otherwise controlling insects. These patches can do so by releasing insect-control materials over selected times and with selected time-release profiles. To manufacture such patches, one or more layers of degradable materials can be impregnated with insect-control materials (such as insect repellents, insecticides, and/or insect attractants). When the resulting patch is initially exposed to the environment, the outermost impregnated layer begins to degrade away. As it does so the degrading impregnated layer thins thereby exposing portions of the insect-control material (that were originally embedded at corresponding depths in the impregnated layer). The degradation thus allows portions of the insect-control materials to disperse near the insect-control patch. When the impregnated layer reaches a sufficiently degraded state, insect-control material in the next outermost layer begins dispersing from the now correspondingly exposed impregnated layer. As a result, patches of the current embodiment can retain their effectiveness for selected periods of time (for instance, hours, days, weeks, months, or even longer) while changing their effects to correspond to expected changes in the environment. Patches of the current embodiment can also be designed to degrade away and leave no or minimal litter and no or minimal insect-control material behind.

Moreover, some embodiments provide apparatus with one or more layers of degradable material which are impregnated with one or more insect-control materials. Optionally, harriers impervious to one or more of the insect-control materials can be supplied on the hack surfaces of the insect-control patches. Furthermore, for apparatus including more than one impregnated layer, the impregnated layers are attached to each other with, for instance, adhesives. The insect-control materials of some patches include insect repellents and insecticides. Moreover, some degradable layers can include an insect attractant to attract insects to an insect repellent within the insect-control patch 18. In some embodiments two of the degradable materials are the same material and one of the corresponding impregnated layers is formed on the other of the impregnated layers to form a releasable bond there between. A backing can also be attached to the apparatus.

Other embodiments provide methods for controlling insects and, more particularly, methods for manufacturing apparatus for controlling insects. Methods of such embodiments include selecting one or more insect-control materials and one or more degradable materials. Each of the degradable materials can be impregnated with one of the insect-control materials to form impregnated layers. One of the impregnated layers of the current embodiment can he attached to a barrier and the impregnated layers can he attached to each other in some desired order. If a patch includes a barrier it can be made of a material impervious to one or more of the insect-control materials. If desired, the attachment of the impregnated layers to each other can be by way of bonding them to each other with an adhesive. Moreover, if desired, a backing can be attached to the barrier.

To the accomplishment of the foregoing and related ends, certain illustrative aspects are described herein in connection with the figures. These aspects are indicative of various ways in which the disclosed subject matter may be practiced, all of which are intended to be within the scope of the disclosed subject matter without limiting the claimed subject matter. Other advantages and novel features may become apparent from the following detailed disclosure when considered in conjunction with the figures.

### BRIEF DESCRIPTION OF THE FIGURES

The detailed description is described with reference to the accompanying figures. In these figures, the left-most digit(s) of a reference number usually identifies the figure in which the reference number first appears. The use of similar reference numbers in different figures usually indicates similar or identical items.

FIG. 1 illustrates a herd of animals subject to insects.

FIG. 2 illustrates an application of an insect-control ear tag to an animal.

FIG. 3 illustrates a cross sectional view of an insect-control patch.

FIG. 4 illustrates a cross sectional view of an insect-control patch applied to a surface.

FIG. 5 illustrates another cross sectional view of an insect-control patch applied to a surface.

FIG. 6 illustrates yet another cross sectional view of an insect-control patch applied to a surface.

FIG. 7 illustrates yet another cross sectional view of an insect-control patch applied to a surface.

FIG. 8 illustrates a method of controlling insects.

### DETAILED DESCRIPTION

This document discloses apparatus and methods for controlling insects and more particularly this document discloses single-layer and multi-layer insect-control patches in which various layers carry insect-control materials such as insect repellents, insecticides, and/or insect attractants impregnated in substrates of the layers which are formed from degradable materials.

FIG. 1 illustrates a herd of animals subject to insects. The animals 10 sometimes attract insects 12 which can be benign, nuisances, or perhaps even threats. For instance, some insects 12 bite the animals 10 to obtain food (i.e. the meat or blood of the animals 10) or to defend themselves. Furthermore, some insects 12 attempt to lay eggs in or on the animals 10 which (as the eggs mature) cause larval forms of the insects 12 to burrow into the animals 10. Each of these bites (and the burrowing of the larva) expose the animals 10 to diseases carried by the insects 12 and/or the larva as well as diseases which can enter the bodies of the animals 10 via the resulting wounds.

While FIG. 1 illustrates the animals 10 as being cattle, the animals 10 could be any type of animal 10. For instance, the animals 10 could be horses, goats, donkeys, mules, poultry, or other animals such as cats or dogs. Indeed, speaking broadly, the animals 10 could include humans. Likewise the insects 12 come in a wide variety. For instance, horse flies, face flies, bot flies, horn flies, other types of flies, lice, ear ticks, deer ticks, other kinds of ticks, mosquitoes, gnats, fleas, honey bees, killer bees, wasps, hornets, and many other types of insects 12 could subject the animals 10 to annoyance, bodily harm, decreased weight-gain (and hence value) or other types of adverse consequences.

It might be worth noting that various insects 12 behave in certain somewhat predictable manners. For instance, some insects 12 seem to favor certain parts of the anatomy of certain animals 10. Furthermore, over time the types of insects 12, their populations, and their behavior tend to change somewhat predictably with the time of the day, the time of the year, the weather, etc. For instance, mosquitoes often become more prevalent a few weeks after heavy rains and insects 12 of various genus and/or species have somewhat predictable breeding, gestation, larval, and maturation seasons.

Furthermore, as illustrated by FIG. 1, one group of animals 10 include animals treated with insect-control tags attached to their ears 14 as shown at the left side of FIG. 1. These tags are frequently referred to as ear tags 16. Another group of animals 10 illustrated on the right side of FIG. 1 are treated with insect-control patches 18 of the current embodiment.

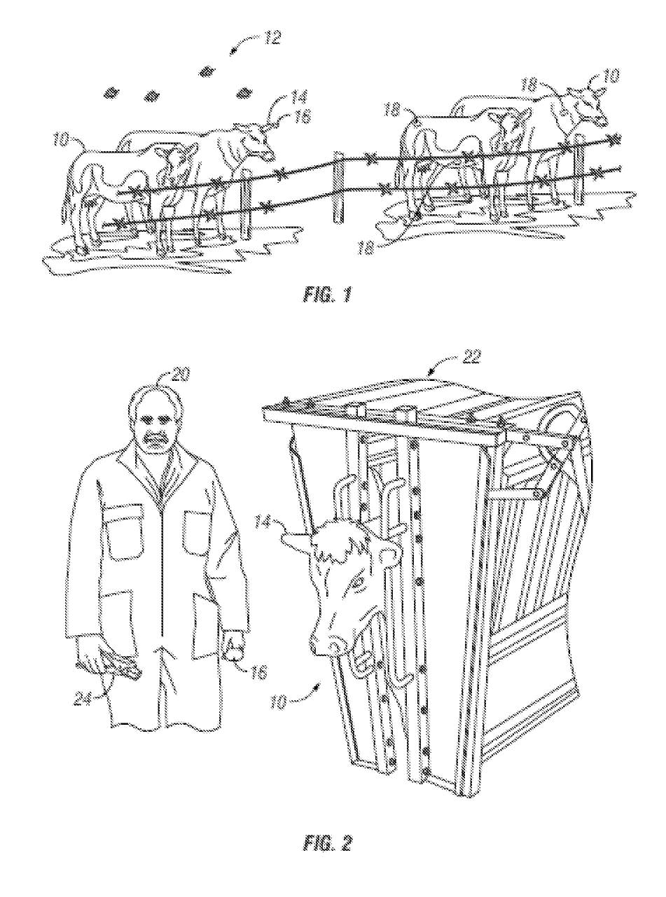

FIG. 2 illustrates the attachment of an ear-tag to an animal. More particularly, FIG. 2 illustrates a user 20 (for instance a ranch hand) preparing to attach an ear tag 16 to an animal 10 (in this case a head of cattle). The user 20 has rounded up the particular animal 10, herded it through a cattle chute, and placed it in a head gate 22. The head gate 22 restrains the animal 10 so that, upon feeling the pain of the ear punching, it can't kick, charge, or otherwise harm the user 20. Some head gates 22 can also fix the head of the animal 10 in a particular pose and/or location so that the user 20 can attend to the animal 10. The user 20 also has an ear punch tool 24 with which the user 20 literally punches a hole through the ear 14 of the animal 10 While it is restrained by the head gate 22. Then the user 20 inserts the ear tag 16 into the resulting hole in the ear 14 of the animal 10 and releases the animal 10. Needless to say, applying the ear tag 16 involves certain labor, expenses, and the possession and use of specialized resources (such as the head gate 22). Plus, it distresses the animal 10. Moreover, the wound left by the ear punch subjects the animal 10 to possible value-impairing infections, diseases, etc. It might also be the case that the owner of the animal 10, or other user 20, might be reluctant to apply an ear tag 16 to one or more animals 10. Horse owners, for instance, might pride themselves on the appearance of their horses and ear tags 16 might be viewed as detracting there from.

Despite the foregoing disadvantages, though, ear tags 16 provide only limited protection to the animal 10 since they can be attached to the animal 10 only by its ears 14. If an insect 12 is not near enough to the ear 14 of the animal 10, the ear tag 16 will deliver little or no effect. Moreover, since ear tags 16 are made of plastic, the insecticides embedded therein must migrate to the surface of the ear tags 16 to be released into the environment. Again, since the insecticides are embedded in the ear tag 16 ever decreasing concentrations of the insecticide reach the surface of the ear tags 16 with correspondingly decreased affectivity for the ear tags 16. Furthermore, insecticides used in ear tags 16 are selected because of their persistence (to environmental factors) to increase the lifetime of the ear tags 16. For that reason, the insecticides in ear tags 16 are often selected from the group of persistent chemicals known as organophosphates. As a result, if the ear tags 16 happen to fall off of the animals 10, plastic debris (the ear tags 16) containing organophospate residue might be left where the ear tags 16 fall.

In contrast to the group of animals 10 treated with ear tags 16, the other group of animals 10 illustrated by FIG. 1 is treated with insect-control patches 18. More particularly, FIG. 1 illustrates that insect-control patches 18 can he attached to the animals 10 at various location such as on/near their necks or heads, their rumps, their flanks, etc. In addition, or in the alternative, insect-control patches 18 could be applied to collars, saddles, clothing, etc. associated with the animals 10. Moreover, insect-control patches 18 can be provided in different sizes, shapes, etc. corresponding to animals 10 of differing sizes and types.

In some embodiments, insect-control patches 18 provide selected time-varying releases of various insect-control materials (i.e., insect repellents, insecticides, and/or insect attractants). The time-varying release of the insect-control materials can be tailored to expected time-varying behavior, population, and other characteristics of the insects 12, the animals 10, and/or the environment. In contrast, ear tags 16 only provide a capability to control the insects 12 which is unvarying but for the detrimental degradation thereof with time and/or exposure to the environment.

Instead of the ear-punch method used with ear tags 16, insect-control patches 18 (see FIG. 1) of the current embodiment can be applied to the animals 10 by pressing the insect-control patches 18 against the animals 10 whereupon adhesives on a surface of the insect-control patches 18 attaches them to the animals 10. Therefore, attaching an insect-control patch 18 to an animal 10 does not distress the animal 10 and involves little (if any) additional labor, expense, specialized resources, etc. over that required for other activities related to attending to the animals 10. Thus, a more detailed discussion of an insect-control patch 18 of the current embodiment might be of interest.

In some embodiments, insect-control patches 18 with a combination of insect attractants and insecticides (as is discussed further herein) could be attached to objects other than the animals 10 such as trees, fences, barns or on poles, to provide “area protection” from insects. The protection provided by the insect-control patches 18 on individual animals could therefore he reinforced by such area protection techniques. More particularly, by placing insect-control patches 18 on immobile objects, an area could be protected with a ring, matrix, pattern, or other arrangement of insect-control patches 18. Such arrangements might he cost-effective for protecting certain areas such as stables, barns, show grounds, milking sheds, work sheds, pastures holding pregnant or young animals. In addition, or in the alternative, insect-control patches 18 could he applied to certain mobile objects (for instance, trucks, tractors, all terrain vehicles, etc.) to provide a degree of protection for the drivers and/or occupants thereof as well as providing protection when such persons might be attending to the animals 10 near these objects.

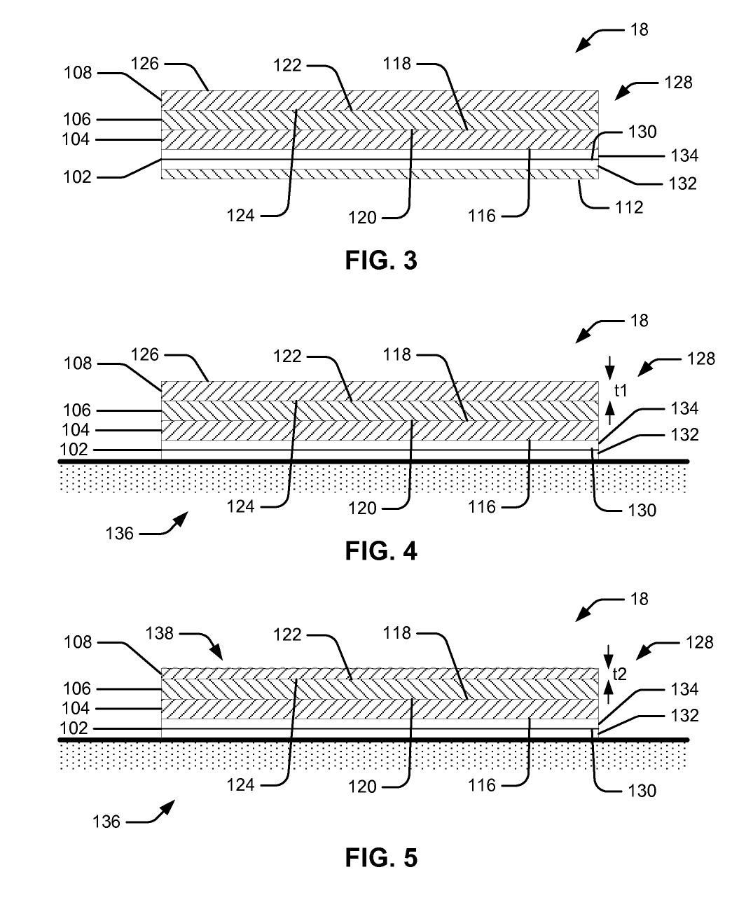

FIG. 3 illustrates a cross sectional view of an insect-control patch. More particularly, FIG. 3 illustrates an embodiment of an insect-control patch 18 which includes a barrier 102, three impregnated layers 104, 106, and 108, and a backing 112. The impregnated layers 104, 106, and 108 have respective surfaces 116, 118, 120, 122, 124, and 126 and include substrates of degradable materials. The degradable materials typically contain one or more insect-control materials such as insect repellents and/or insecticides impregnated therein. In some instances, an insect attractant could be impregnated in one of the impregnated layers to, for instance, attract insects to an insect repellent in one of the impregnated layers 104, 106, or 108. Interestingly, these insect control materials need not have a particular persistence with respect to environmental factors since they remain impregnated within the degradable materials (and thus isolated from the environment) until the degradable materials degrade sufficiently to release the insect control materials into the area near the insect-control patches 18. This aspect, and/or other aspects, of the insect control patches 18, allow for the selection of insect-control materials from a broader range of the available chemicals than those used in conjunction with ear tags 16. For instance, chemicals relatively lacking in persistence but environmentally benign can be used in insect control patches 18 of various embodiments.

In some cases the impregnated layers 104, 106, and 108 can include materials other than insect repellents, insecticides, and insect attractants. For instance, an inert material could be impregnated in the substrate of a particular impregnated layer 104, 106, or 108 if no insect control is desired during a corresponding time. Incorporating such time-breaks in the time-based profiles of certain insect-control patches 18 can allow for periods during which these insect-control patches 18 lay dormant. For instance, an insect-control patch 18 can be designed to be applied at one time of the year (possibly late summer or early fall) and which remains dormant through some time (possibly the winter) yet becomes active at some later time (possibly in the spring).

As FIG. 3 illustrates, the impregnated layers 104, 106, and 108 can be attached to each other along their respective surfaces 118, 120, 122, and 124 or portions thereof. Thus, initially, the outermost layer 126 of the outermost impregnated layer 108 will be exposed to the environment when the insect-control patch 18 is taken out of its packaging (if any) and placed on an animal 10 or other object. Note that, except where context indicates otherwise, herein the term “outermost” will be used to mean being positioned furthest from the backing 112 with the term “innermost” meaning being positioned nearest the backing 112. That being said the insect-control material impregnated in the outermost impregnated layer 108 will begin to disperse into the vicinity near the insect-control patch 18 upon the exposure of the outermost impregnated layer 108 to the environment. In some embodiments, the dispersion is by way of out-gassing, dissolution from the degradable material of the impregnated layer 108, release from the degradable material as it degrades, mechanical transfer, mechanical abrasion, etc. Accordingly, the insect-control patch 18 will initially affect the insects 12 in a manner dependent on the particular insect-control material in that impregnated layer 108, its concentration therein, the surface area of that impregnated layer 108, etc. With exposure to the environment, though, the degradable substrate of that impregnated layer 108 will wear away or otherwise dissolve, disintegrate, disappear, degrade, etc. The rate of such degradation could be influenced by environmental factors such as the temperature, the humidity, the incidence of ultraviolet (UV) radiation, the concentration of oxygen, the concentration of a particular microbe or microbes, fungi, molds, etc. Colloquially, such types of degradation can be referred to as “biodegradation” and materials which degrade in such non-limiting manners can be referred to as “biodegradable.” Nonetheless, as a result of such degradation (no matter which environmental factor causes, enables, or triggers the degradation) the outermost impregnated layer 108 will degrade in a manner corresponding to the manner in which its degradable material degrades.

Once the outermost impregnated layer 108 degrades sufficiently, the impregnated layer 106 adjacent to the outermost impregnated layer 108 and inward there from will be exposed (in part or in whole) thereby allowing that degradable layer 106 to begin releasing its corresponding insect-control material. That degradable layer 106 too will disappear with exposure to the environment thereby exposing the next impregnated layer 104 and releasing the corresponding insect-control material. Note that while an exposed impregnated layer 104, 106, or 108 will be releasing its insect-control material, other impregnated layers 104, 106, or 108 might also be releasing some amount of their corresponding insect-control materials via its migration through the other impregnated layers 104, 106, and 108 or from their own exposed sides 128 (as opposed to surfaces 116, 118, 120, 122, 124, and 126).

These processes can continue until all of the impregnated layers 104, 106, and 108 degrade in whole or in part. Over some time, therefore, the insect-control patch 18 can have a time-varying and tailored effect upon the insects 12. Such insect-control patches 18 can also thereafter (in some embodiments) disperse in their entirety.

With continuing reference to FIG. 3, the drawing illustrates that the barrier 102 can be coated with adhesives 132 and 134 on either side thereof. The adhesives 132 and 134 can be the same adhesive or different adhesives. Moreover the barrier 102 can be made from a material impervious to the insect-control material in the innermost impregnable layer 104 and/or the other insect-control materials of the insect-control patch 18. Thus, the barrier 102 can prevent the insect-control materials of the insect-control patch 18 from coming into contact with the animals 10. FIG. 3 also illustrates that the impregnated layers 104, 106, and 108 can he attached to the barrier 102 so that the barrier 102 can serve to attach the insect-control patch 18 to an animal 10 or other object. In addition, FIG. 3 illustrates that the insect-control patch 18 can include the backing 112 which can be made of any material suitable for preventing the adhesive 132 on the innermost surface of the barrier 102 from contacting other objects (at least until the backing 112 is removed).

While adhesives can be used to attach the various impregnated layers 104, 106, and 108 to each other such manufacturing techniques are merely illustrative and do not limit the scope of the disclosure. For instance, the impregnated layers 104, 106, and 108 could be mechanically joined to each other. In the alternative, or in addition, the impregnated layers 104, 106, and 108 can he joined to each other by placing one impregnated layer on (or adjacent to) another impregnated layer and feeding the combination through a pair of rollers. Another way in which the impregnated layers 104, 106, and 108 could be formed and/or joined to each other is by co-extruding them from a die or other device. The co-extruded impregnated layers 104, 106, and 108 could also be fed through rollers to further bond them together. Co-extrusion of the impregnated layers 104, 106, and 108 can provide for high volume manufacture of insect-control patches 18 of various embodiments.

Having discussed some embodiments of insect-control patches 18, it might be useful at this juncture to discuss insect-control patches 18 as they might be used. Thus, FIGS. 4-7 illustrate an insect-control patch 18 in use in an environment.

More particularly, FIG. 4 illustrates a cross sectional view of an insect-control patch 18 applied to a surface. FIG. 4 also illustrates that the insect-control patch 18 of the current embodiment has been adhered to an animal 10 (see FIG. 1) and more particularly to its skin 136. As FIG. 4 illustrates, the backing 112 (not shown in FIG. 4, but see FIG. 3) has been peeled off or otherwise removed from the insect-control patch 18 thereby allowing adhesive 132 to adhere to the skin 136 of the animal 10. Furthermore, the outer surface 126 of the outermost impregnated layer 108 has been exposed to the environment. Thus, as the outermost impregnated layer 108 degrades, it affects the insects 12 (see FIG. 1) in the vicinity of the insect-control patch 18 (and the corresponding portion of the animal 10).

FIG. 5 illustrates another cross sectional view of an insect-control patch applied to a surface. Again, as with FIGS. 3 and 4, the insect-control patch 18 is adhered to the skin 136 of the animal 10. However, the outermost impregnated layer 108 has begun to degrade as illustrated by the worn or degraded surface 138 (which formed from the original outer surface 126 of the outermost impregnated layer 108). As a result, whereas the outermost impregnated layer 108 initially had a thickness t1 (see FIG. 4), it now has a thickness t2 (see FIG. 5).

Moreover, while FIGS. 4 and 5 illustrate the outermost impregnated layer 108 as developing an uneven degraded surface 138 and a decreasing thickness (from t1 to t2), those of ordinary skill in the art will recognize that the degradation of the outermost impregnated layer 108 (and the other impregnated layers 104 and 106) can occur by many mechanisms and/or in a variety of manners. For instance, the impregnated layers 104, 106, and 108 of the current embodiment could become porous, could wear away evenly, etc. Nonetheless, the outermost impregnated layer 108 degrades with time and exposure to the environment thereby renewing the surface(s) exposed to the environment and allowing a portion of the insect-control material at or near the degrading and/or retreating surface to disperse from the impregnated layer 104, 106, or 108. Furthermore, it might be worth noting that the dispersal rate of the corresponding insect-control material might depend on the condition of the degraded impregnated layer 104, 106, or 108 and its thickness t2. Thus, since the dispersal rate might vary with conditions other than the thickness t2 (for instance porosity) the dispersal rate can depend on an “effective thickness” that accounts for the actual thickness t2 and such other conditions.

In some embodiments, sonic impregnated layers 104, 106, and 108 can include chemicals impregnated therein, applied thereto, or otherwise added to modify the rate at which these layers degrade. For instance, fungicides, anti-bacterials, UV inhibitors, etc. can be included in one or more of the impregnated layers 104, 106 and 108 if desired. Copper sulphate represents one such fungicide while carbon black represents one such UV inhibitor. While both copper sulphate and carbon black are generally benign with respect to the environment these particular chemicals are merely illustrative and do not limit the scope of the disclosure. Thus, the time-based profile of insect-control patches can further be optimized using such techniques.

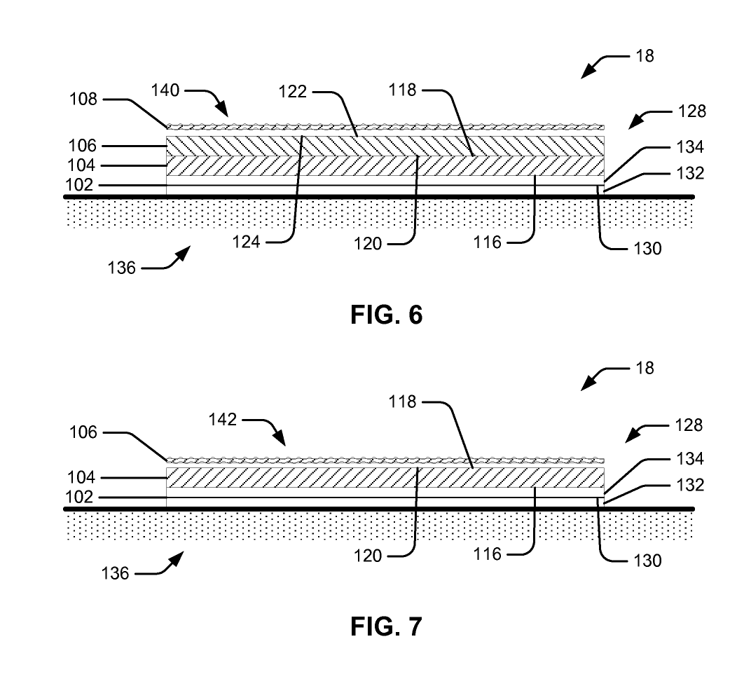

FIG. 6 illustrates yet another cross sectional view of an insect-control patch applied to a surface. Indeed, FIG. 6 illustrates that the outermost impregnated layer 108 has degraded to such an extent that merely a remnant 140 thereof remains. That remnant 140 as illustrated by FIG. 6 has separated from the next outermost impregnated layer 106. Since the remnant 140 only includes the remains of its degradable substrate and the insect-control material impregnated therein (which need not be selected for its persistence and can he environmentally benign), the remnant 140 can eventually disappear in its entirety. While FIG. 6 illustrates the remnant 140 separating as a whole, those skill in the art will recognize that the remnant 140 might separate in pieces or that the outermost impregnated layer might degrade away uniformly thereby never leaving a detectable remnant 140.

FIG. 7 illustrates yet another cross sectional view of an insect-control patch applied to a surface. In FIG. 7 (following the separation of remnant 140 from the insect-control patch 18), the impregnated layer 106 just to the inside of where the outermost impregnated layer 108 was has degraded to another remnant 142. Moreover, FIG. 7 illustrates the insect-control patch 18 at a time at which the remnant 142 of that impregnated layer 106 has also separated from the remainder of the insect-control patch 18. Of course, now that the remnant 142 of the impregnated layer 106 has separated (and/or disappeared) the next most inward impregnated layer 104 has been exposed and begins to degrade. Accordingly, it begins to release its insect-control material or begins releasing that insect-control material at a rate corresponding to the degree of exposure of the impregnated layer 104 and to the corresponding degradation of the newly exposed impregnated layer 104.

Thus, FIGS. 4-7 illustrate that as a result of the serial degradation of the impregnated layers 104, 106, and 108, one insect-control material after another disperses from the insect-control patch 18. Moreover, because of the decreasing thickness t2 (and/or the effective thickness) of the impregnated layers 104, 106, and 108, portions of the corresponding insect-control materials previously embedded in one of the impregnated layers 104, 106, or 108 but now at (or near) the corresponding surface can be exposed. As a result, the performance of the insect-control patch 18 varies with time as determined by the selection of the materials (and other aspects) of the various impregnated layers 104, 106, and 108. It might be worth noting that the materials of the adhesive layers 132 and/or barrier 102 could also be selected to degrade with exposure to the environment such that the barrier 102 either separates from the animal or disappears at some point. Thus, at this juncture it might now be useful to discuss methods of manufacturing various insect-control patches 18.

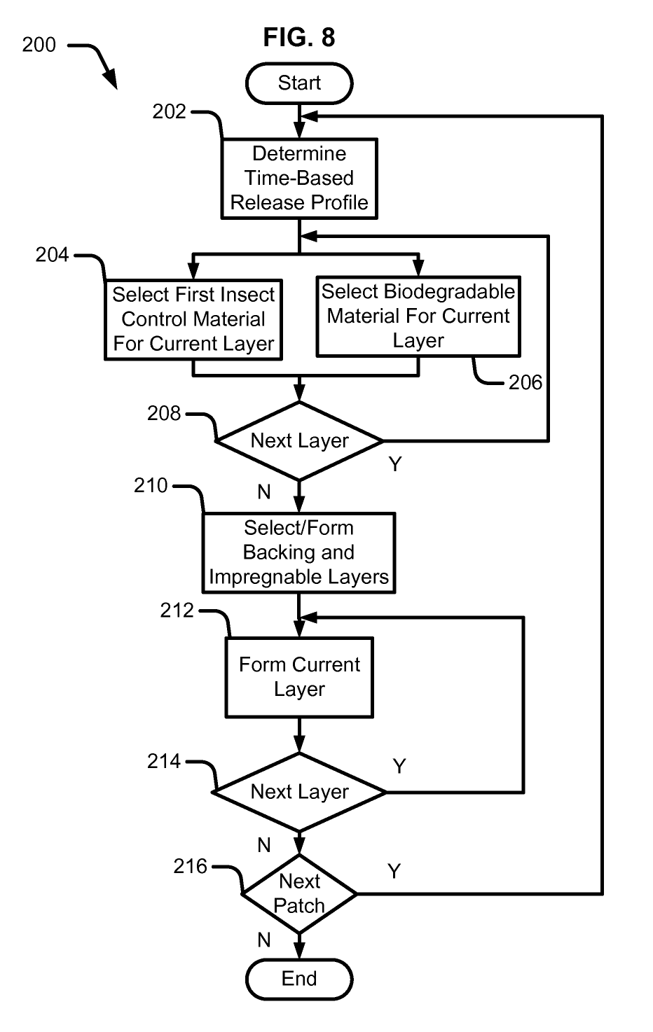

FIG. 8 illustrates a method of controlling insects and more particularly a method of manufacturing insect-control patches of some embodiments. In the current embodiment the method 200 includes determining a time-based profile for the release of various insect-control materials. In other words, a user can determine which insects 12 are likely to be present in an environment during some time, what behaviors the insects 12 might exhibit, and other characteristics of the environment and determine a desired profile for the time-based release of various insect-control materials. See reference 202. During some time corresponding to a portion of that profile the user might decide that a release of a certain amount of insect-control material might be desirable. Accordingly, the user can select that insect-control material for inclusion in an impregnated layer 104, 106, or 108 of an insect-control patch 18 corresponding to that portion of the time-based profile. See reference 204. The user can also select a degradable material within which the insect-control material (which was selected at reference 204) can be impregnated. The user can also select the thickness t1 to which the impregnated layers 104, 106, or 108 can be manufacture and its width, its breadth, etc. to tailor it according to conditions within which the impregnated layer 104, 106, or 108 is expected to operate. See reference 206.

As indicated at reference 208, the user can select insect control materials and degradable materials for various times and corresponding impregnated layers 104, 106, and 108) during which it might be desirable to affect the insects 12. For instance, if it is not desired to affect the insects 12 during a particular time, an inert or benign material (or none whatsoever) can be selected for inclusion in the corresponding impregnated layer 104, 106, or 108. On the other hand, an insect repellent could be selected for inclusion in a particular impregnated layer 104, 106, or 108. In the alternative or in addition, it might be desired to select an insecticide for inclusion in some impregnated layer(s) 104, 106, or 108.

Since the chances of the insecticide killing an insect 12 will increase if the insect 12 comes into contact with the insecticide, the user could choose to include an insect attractant in one or more of the impregnated layers 104, 106, or 108 (such as one carrying an insecticide). In any case, method 200 can proceed as indicated by reference 208. Thus, in reference 210, a material which is impervious to one or more of the insect-control materials can be selected (as can the adhesives 132 and 134) for the barrier 102.

At some time, manufacture of the insect-control patch 18 (or patches) might be desired. As a result, the impregnated layers 104, 106, and 108 can be formed. See reference 212. Other portions of the insect control patch 18 can also be formed at some time. For instance, the backing 112 can be formed and set upon (or adjacent to) a suitable surface (or sonic manufacturing jig) and the barrier 102 can be attached thereto by application of the adhesive 132. The adhesive 134 could then be applied to the barrier 102. Thereafter, the innermost impregnated layer 104 (the one from which an insect control material is to be released last) can be formed on or attached to the adhesive 134.

If desired, a bonding material can be applied to the outermost surface 118 (see FIG. 3) of the innermost impregnated layer 104. Thereafter, the next impregnated layer 106 can be formed on the innermost impregnated layer 104 with the bonding agent holding the two impregnated layers 104 and 106 together. The bonding agent can be chosen to have characteristics sufficient to attach the impregnated layers 104 and 106 to each other.

The bonding agent can also be selected such that its characteristics allow it to release the more outer impregnated layer 106 from the more inner impregnated layer 104 upon exposure to the environment due to an environmental factor or for other reasons. Thus, as the more outer impregnated layer 106 degrades, the environment can begin affecting (and/or weakening) the bonding agent. The bonding agent could therefore release the remnant 142 of the more outer impregnated layer 106 at a time selected by the user. Various mechanisms could be relied on to cause the bonding agent to release the remnant 142 (see FIG. 7) of the impregnated layer 106. For instance, the bonding agent could degrade in the presence of ultraviolent radiation (i.e. the UVA or UVB radiation present in sunlight), moisture, oxygen, microbes, etc.

In an alternative to using a bonding (and/or release) agent, it might be desired to manufacture one impregnated layer 106 upon another impregnated layer 104. In such cases, the respective degradable materials of both of the impregnated layers 104 and 106 could be selected in part or in whole upon their ability to temporarily bind or adhere to each other and thence to cease such binding upon exposure to the environment. For instance, if the two degradable materials of these impregnated layers are the same, separate formation of the layers can cause a relatively weak bonding there between that is sufficient to bind the layers together for some desired time after exposure to the environment. At some point the outermost of the impregnated layers 104, 106, and 108 could be formed and/or attached to the insect-control patch 18. Whereupon the insect control patch 18 could be packaged. In some embodiments the packaging could he chosen to prevent the onset of degradation of the impregnated layers 104, 106, and 108. Moreover, at some point, it might be desired to manufacture another insect-control patch 18 or another type of insect-control patch 18. Thus, reference 216 indicates that method 200 could be repeated in whole or in part.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts disclosed above are disclosed as non-limiting forms of implementing the claimed subject matter.

1. An apparatus comprising:
a first layer of a first degradable material impregnated with a first insect-control material and having an effective thickness which decreases as the first degradable material degrades at a selected rate thereby exposing a portion of the first impregnated insect-control material corresponding to the decreased effective thickness;
a second layer of a second degradable material impregnated with a second insect-control material, defining first and second surfaces, and being attached to the first layer along a portion of the first surface wherein as the effective thickness decreases the second degradable layer is correspondingly exposed; and
a barrier of a material impervious to the second insect-control material and being attached to the second degradable layer.

2. The apparatus of claim 1 wherein the first degradable material is selected so that the rate at which it degrades is a function of an environmental factor selected from the group consisting of a temperature, a humidity, an ultraviolet radiation level, an oxygen concentration, and a microbe concentration.

3. The apparatus of claim 1 wherein the attachment of the first and second layers is by way of a bonding.

4. The apparatus of claim 3 wherein the first and the second degradable materials are the same degradable material and the bonding is created by forming one of the first or second impregnated layers on the other of the first or second impregnated layers.

5. The apparatus of claim 4 wherein the bonding is by way of an adhesive.

6. The apparatus of claim 1 wherein the barrier is attached to the second degradable layer by an adhesive.

7. The apparatus of claim 1 further comprising a backing attached to the barrier.

8. The apparatus of claim 1 further comprising a third layer of a third degradable material impregnated with a third insect-control material and being attached to the first degradable layer.

9. The apparatus of claim 1 wherein the first insect-control material is an insecticide.

10. The apparatus of claim I wherein the first and second degradable materials are the same degradable material and wherein the second layer is formed on the first layer.

11. A method comprising:
selecting a first insect-control material;
selecting a first degradable material;
selecting a second insect-control material;
selecting a second degradable material;
impregnating a layer of the first degradable material with the first insect-control material thereby forming a first impregnated layer defining an effective thickness;
impregnating a layer of the second degradable material with the second insect-control material; and
attaching the first and second impregnated layers to each other wherein the effective thickness to decrease as the first degradable material degrades at a selected rate thereby exposing a portion of the first impregnated insect-control material corresponding to the decreased effective thickness and wherein as the effective thickness to decrease the second impregnated layer is exposed correspondingly.

12. The method of claim wherein the first degradable material is selected so that the rate at which it degrades is a function of an environmental factor selected from the group consisting of a temperature, a humidity, an ultraviolet radiation level, an oxygen concentration, and a microbe concentration.

13. The method of claim 11 wherein the attaching of the first and second impregnated layers further comprises bonding the first and second layers to each other.

14. The method of claim 11 wherein the first and the second degradable materials are the same degradable material.

15. The method of claim 11 further comprising attaching a backing to the second degradable layer.

16. The method of claim 11 further comprising:
selecting a third insect-control material;
selecting a third degradable material;
impregnating a layer of the third degradable material with the third insect-control material; and
attaching the second and third impregnated layers to each other.

17. The method of claim 11 further comprising:
selecting an insecticide;
selecting a third degradable material;
impregnating a layer of the third degradable material with the insecticide; and
attaching the second and third impregnated layers to each other.

18. The method of claim 11 further comprising forming the second impregnated layer on the first impregnated layer wherein the first and second degradable materials are the same degradable materials.

19. An apparatus comprising:
a first layer of a first degradable material impregnated with a first insect-control material and defining an effective thickness and defining a degradation rate of the first layer dependent on an environmental factor; and
a second layer of a second degradable material impregnated with a second insect-control material, defining a surface, and being attached to the first layer along a portion of the surface wherein the insect-control materials are each selected from the group consisting of an insect repellent, an insecticide, an insect attractant and a benign material.

20. The method of claim 19 wherein the environmental factor is selected from the group consisting of a temperature, a humidity, an ultraviolet radiation level, an oxygen concentration, and a microbe concentration.
